(19) United States
(12) Patent Application Publication
(10) Pub. No.: US 2013/0312501 A1
(43) Pub. Date: Nov. 28, 2013

(54) Inline filter housing assembly

(71) Applicant: Michael W. Dewey, Sausalito, CA (US)

(72) Inventor: Michael W. Dewey, Sausalito, CA (US)

(73) Assignee: WYATT TECHNOLOGY CORPORATION, Santa Barbara, CA (US)

(21) Appl. No.: 13/479,695

(22) Filed: May 24, 2012

(51) Int. Cl. G01N 30/02

(52) U.S. Cl. 73/61.56

(57) ABSTRACT

A novel filter housing assembly for use in liquid chromatography and similar fluid flow based systems capable of use at high pressure, well above 1000 psi, is disclosed. The filter housing assembly has a very low dead volume of approximately 11 μL and is capable of holding brittle ceramic filter membranes as well as flexible membranes without the support of a fit. The filter housing is capable of being assembled and disassembled by hand without the need of any tools and makes use of an inexpensive, disposable filter retaining screen.

### FIELD OF THE INVENTION

The present invention relates generally to an apparatus for filtering a fluid stream and, more particularly to a filter housing and assembly for removing particles, dust, contaminants and other detritus from high pressure fluid flow streams, and more particularly from flow streams used in fluid analysis systems such as high performance liquid chromatography and relevant detection systems.

### BACKGROUND

High performance liquid chromatography (HLPC) also known as high pressure liquid chromatography, and size exclusion chromatography (SEC), is a commonly used technique for separation of particles and/or molecules in a liquid sample. HPLC systems may typically employ pressures greater than 1000 psi. High pressures are generally necessary to push the fluid sample through SEC columns where the molecules within the sample are separated by size, with the largest particles eluting first.

Various detection systems are frequently used in conjunction with HPLC systems. Among the detection methods employed are static light scattering, also known as multi-angle light scattering (MALS); dynamic light scattering (DLS), also known as quasi-elastic light scattering (QELS) and photon correlation spectroscopy (PCS); viscometry; differential and interferrometric refractometry; and UV absorbance. These methods of detection are frequently used in conjunction with each other following separation of the molecules in the sample to provide important information on the sample being analyzed, such as molar mass, molar size, size and mass distributions, viscosity, and fluorescence.

Many of the detection methods used for the analysis of a fluid sample, in particular the light scattering methods, can be extremely sensitive to particulate contaminants within the flow stream. An abundance of dust or other detritus, including column shedding, can cause light scattering measurements to produce erroneous results. In addition, the fine tubing used to connect the various detectors, in addition to the detection cells themselves can become clogged or contaminated by any detritus within the flow stream that reaches them. It is therefore of critical importance that unwanted particles within the flow stream are minimized, and thus proper filtration along the flow path is essential. It is an objective of the present invention to provide a simple yet effective inline filter which can be used in conjunction with the various measurement systems used for fluid analysis. As measurements of fluid samples are often made at high pressures, such as those used in HPLC and field flow fractionation (FFF) systems, it is imperative that the filtration mechanism utilized be capable of supporting these pressures, often exceeding 1,000 psi. It is therefore another objective of the present invention to provide a filter housing capable of operating at these pressures without leaking or causing damage to the often delicate filter itself. It is a further objective of the invention to allow a user to replace the filter within the housing with relative ease. Another objective of the present invention is to eliminate problems associated with frits, which are used often to support the fragile filter element. Among the negative aspects of frits as part of a filter assembly are that they add dead volume to the assembly and provide an area for undesirable sample adsorption.

### BRIEF DESCRIPTION OF THE INVENTION

A novel filter housing and assembly is disclosed. The housing is capable of supporting high pressure typical of HPLC systems. The filter assembly is capable of holding both brittle and flexible filter elements without the support of a frit. Another benefit of the disclosed invention is its ability to be assembled and tightened by hand without the need for tools.

### BRIEF DESCRIPTION OF THE DRAWINGS

FIG. 1 shows a typical HPLC-MALS setup including a filter member.

FIG. 2 shows a typical HPLC filter housing and assembly.

FIG. 3 shows one embodiment of the novel filter housing assembly of the present invention as assembled.

FIG. 4 shows an exploded view an embodiment of present invention with internal elements exposed.

FIG. 5 illustrates the method of assembly for an embodiment of the novel filter housing.

FIG. 6 shows a cross section of an embodiment of the novel invention when assembled.

FIG. 7 is a close-up cross section of the flow area near the filter of the assembled invention as shown in FIG. 6.

### DETAILED DESCRIPTION OF THE INVENTION

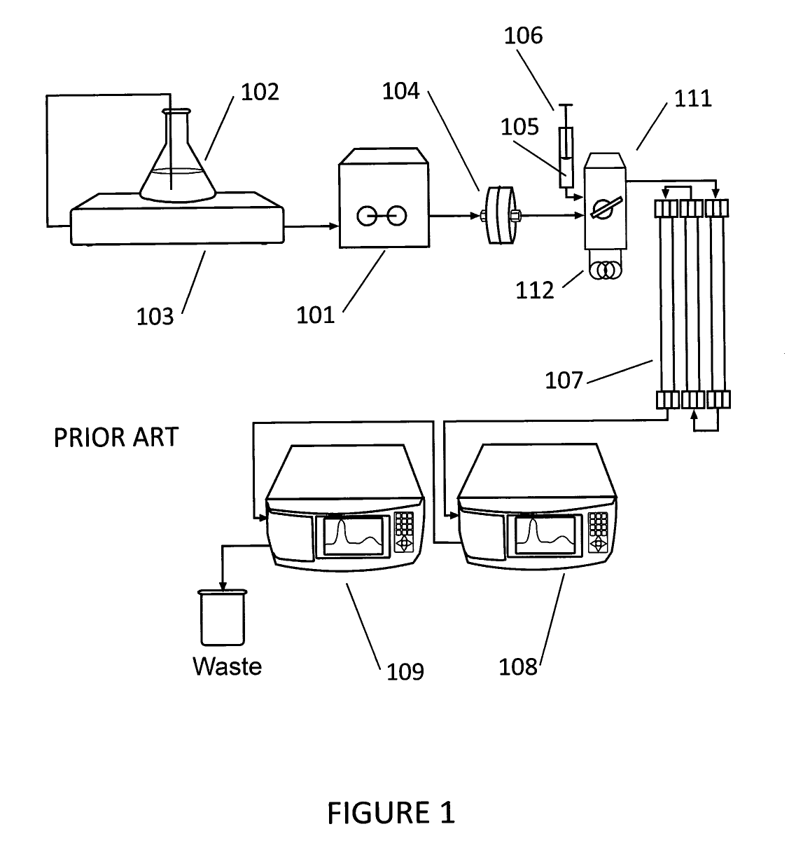

A typical SEC-MALS setup is shown in FIG. 1. Solvent is generally drawn by an HPLC pump 101 from a solvent reservoir 102 through a degasser 103 and then pumped through filtering means 104 to the injection valve 111. A liquid sample 105 is injected into the sample loop 112 of the injection valve 111, generally by a syringe 106. The sample, however, may be added to the flow stream by means of an auto injector rather than the manual means described. The fluid sample then flows from the injector through one or more SEC columns, where the molecules or particles contained within the sample are separated by size, with the largest particles eluting first. The separated sample then passes sequentially through MALS detector 108 and a concentration detector such as a differential refractometer 109 before passing to waste. Other instruments capable of measuring the physical properties of the molecules or particles in the sample may also be present along the flow stream. For example, a UV/Vis absorbance detector and/or a viscometer might be present within the chain of instruments. In general data generated by the instruments is transmitted to a computer which is capable of collecting, storing, and analyzing the data and reporting the results to the user. Filter means 104 is generally incorporated as shown to remove residual particulate material from said solvent that could interfere with the desired measurements. One example of an HPLC pump is the model G1310 isocratic pump from Agilent Technologies, Inc., Santa Clara, Calif. An example of a degasser is the Systec Multi-Channel Vacuum Degasser, available from Upchurch Scientific, Oak Harbor, Wash. An example of an injection valve is the model 7725 analytical injector, also from Upchurch Scientific.

An FFF-MALS system is similar in many respects to the SEC-MALS system shown in FIG. 1, except that the FFF channel replaces the SEC columns, and various means for controlling the pump or pumps required for FFF will be present. FFF is well known and was described by J. Calvin Giddings in his 1993 Science paper, volume 260, pages 1456-1465. The means by which particles are fractionated by FFF is also discussed in pending U.S. application Ser. No., 12/157,367 filed Jun. 9, 2008 by Wyatt, et.al, and which is hereby incorporated by reference. FFF systems have been used in conjunction with MALS measurements for many years. In addition to FFF and SEC systems, other separation and fluid transport techniques such as reversed phase chromatography (RPC), ultra high performance liquid chromatography (UPLC), and fast protein liquid chromatography (FPLC) may also benefit from one or more filter members to keep the flow stream free of unwanted particulates. It should also be noted that lower pressure systems and techniques such as Composition Gradient MALS (CG-MALS), where fluid may be delivered by one or more syringe pumps, may also make use of inline filtration.

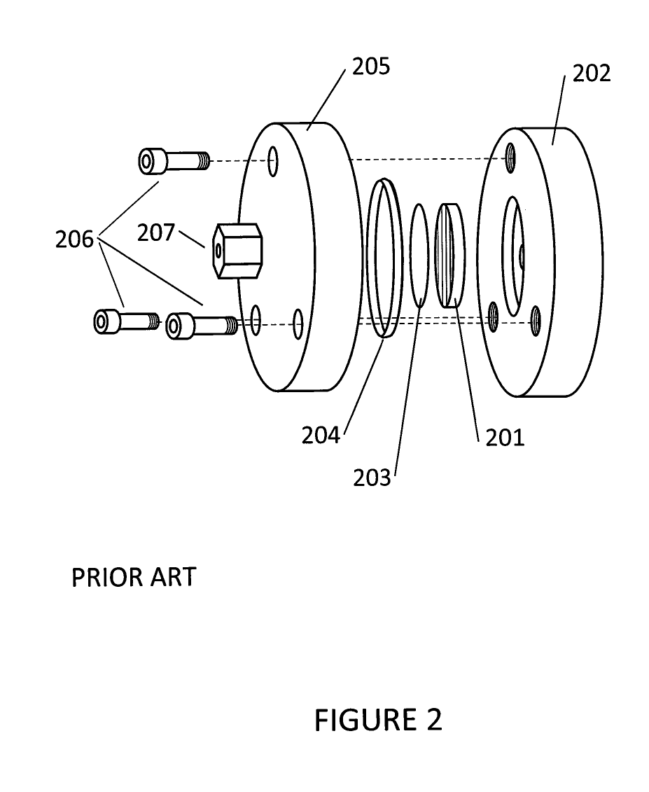

Although advances have been made in recent years in the design of inline filters, such as in U.S. Pat. Nos. 6,095,572 and 6,361,687, “Quarter turn quick connect fitting,” by Ford, et.al., (Issued on Aug. 1, 2000 and Mar. 26, 2002 respectively), traditional inline filtration mechanisms have been cumbersome, required tools to assemble, and were often difficult to clean, particularly when elements of the filter itself would adhere to the expensive, non-disposable filter support screen. FIG. 2 shows a traditional filter housing assembly. A filter support screen 201 is seated into the outlet end of the filter housing 202. A circular ceramic or membrane filter 203 is placed on the support element 201 and sealed by an O-ring 204. The inlet end of the filter housing 205 is then connected to the outlet end of the filter housing 202 by means of bolts 206. Flow enters the filter housing the inlet port 207 of the inlet end of the filter housing, passes through the filter element 203 prior to passing through the filter support element 201 and out through the outlet port (not shown) in the outlet housing 202. Flow pressure pushes the filter element onto the filter support element, and often causes the filter to become adhered thereto. When the filter itself must be replaced, it is often difficult to remove from the support element, and careful attention must be taken to insure that any broken pieces from the filter are removed lest they potentially cause the replacement filter to rip or crack. Another drawback to this conventional design is the difficulty associated with the disassembly of the housing, which generally requires tools.

The present invention overcomes many of the negative elements associated with traditional inline filters while providing a simple assembly while taking maximum advantage of inexpensive, disposable elements. Further, the inventive housing assembly supports the use of both brittle ceramic filter membranes, such as the Anodisc filter produced by Whatman, a division of GE Healthcare, as well as flexible membrane filters made from materials such as polyvinylidene fluoride (PVDF) or polycarbonate. Both of these common filters are useable with the present invention without the support of a backing fit. Most inline filter housings make use of a frit as a filter support element. Frits used in inline filters are generally disc shaped elements made of porous metal, ceramic or other materials such as PEEK. As frits are three dimensional structures with a depth, frequently of 1-3 mm, The pores within the frit may trap sample molecules which may adhere to its many surface elements or may be adsorbed by the material itself. When the frit material is exposed to a different solvent or solution conditions, the adhered or adsorbed samples may be released from the frit material and travel through the outflow of the filter housing, be detected by downstream detectors and lead to erroneous results. Further as fits have a depth associated with them, they add significant dead volume to the filter housing assembly.

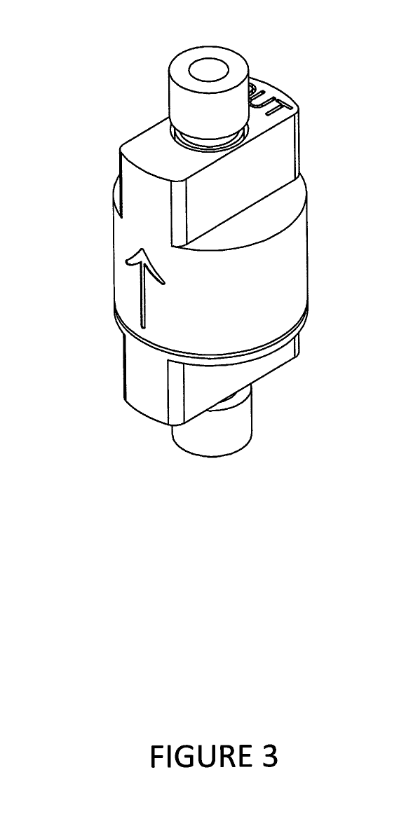

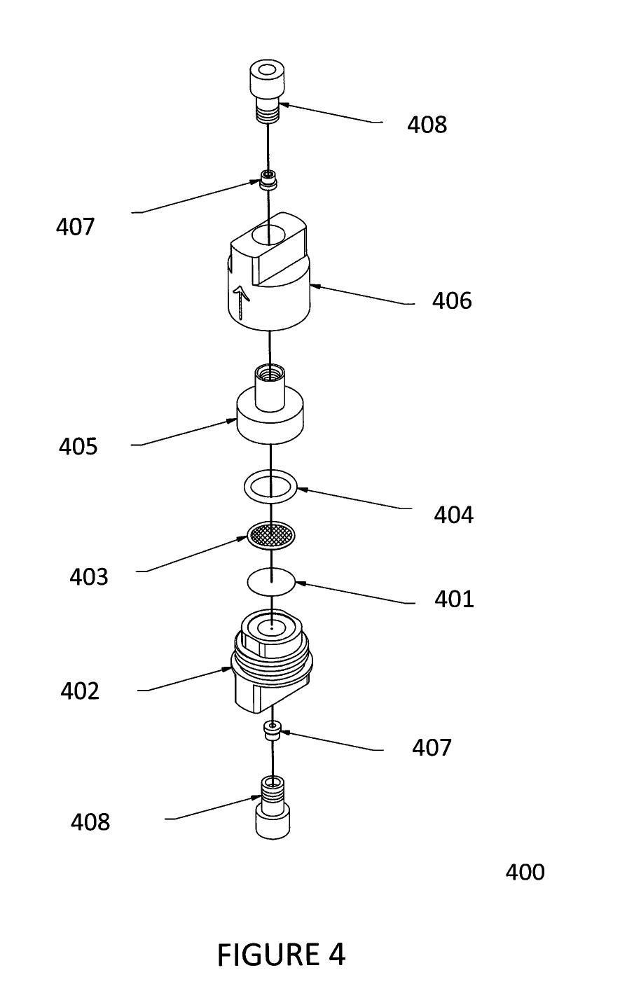

FIG. 3 illustrates the compact nature of the inventive filter housing of the present disclosure as well as its simple means of assembly. FIG. 4 shows the elements of one embodiment of the invention. A filter element 401 will be sandwiched between inlet filter housing 402 and retaining screen element 403. The inexpensive retaining screen 403, while porous in the central region may be solid, in a preferred embodiment, along its perimeter. As opposed to a frit, this thin screen does not adsorb sample elements, nor is there an associated depth of material to absorb sample, nor is there a dead volume associated therewith. Further the screen element allows an improved, uniform flow through the filter into the chamber downstream therefrom due to the uniformity of the retaining screen as opposed to a supporting frit which may or may not be of uniform composition. Another benefit of the screen element is that there is likely to be less flow impedance over the exposed surface of the filter element in contrast to a filter supported by a fit, which will likely have more a larger non-porous area in contact with the filter element. Upon the perimeter of the screen is seated an O-ring 404 or gasket which seals the screen to the O-ring retaining element 405, which is keyed to prevent it from rotating relative to the inlet filter housing 402. The O-ring retainer 405 is threaded to receive a properly threaded outlet fitting. The outlet filter housing 406 is threaded so as to allow it to mate with outlet filter housing 402. As the two halves of the filter housing 402 and 406 are tightened together, they compress the O-ring 404 and seal the assembly. As the O-ring retainer is not threaded, but is keyed to the inlet filter housing 402 it remains fixed relative to the inlet filter housing 402 but allows the outlet filter housing 406 to rotate freely relative thereto during the assembly. This novel design makes it impossible for the filter element 401 to be rotated during the assembly process, thereby ensuring a fully assembled filter housing assembly 400 whose integrity has not been compromised by possible tearing or cracking of the filter element while the assembly is sealed. The assembled filter housing assembly may then be placed in-line with a chromatography or other flowing system by connecting tubing from the upstream source to the inlet filter housing by means of a ferrule 407 and a fitting 408. A corresponding ferrule 407 and fitting 408 may be used on the outlet side through which the fluid will be delivered downstream of the filter. In an alternate embodiment of the invention, particularly relevant to lower pressure systems, the filter housings 402 and 406 may be threaded so as to receive coned inlet and outlet fittings rather than the flangeless fittings 408 and accompanying ferrules 407 shown in FIG. 4.

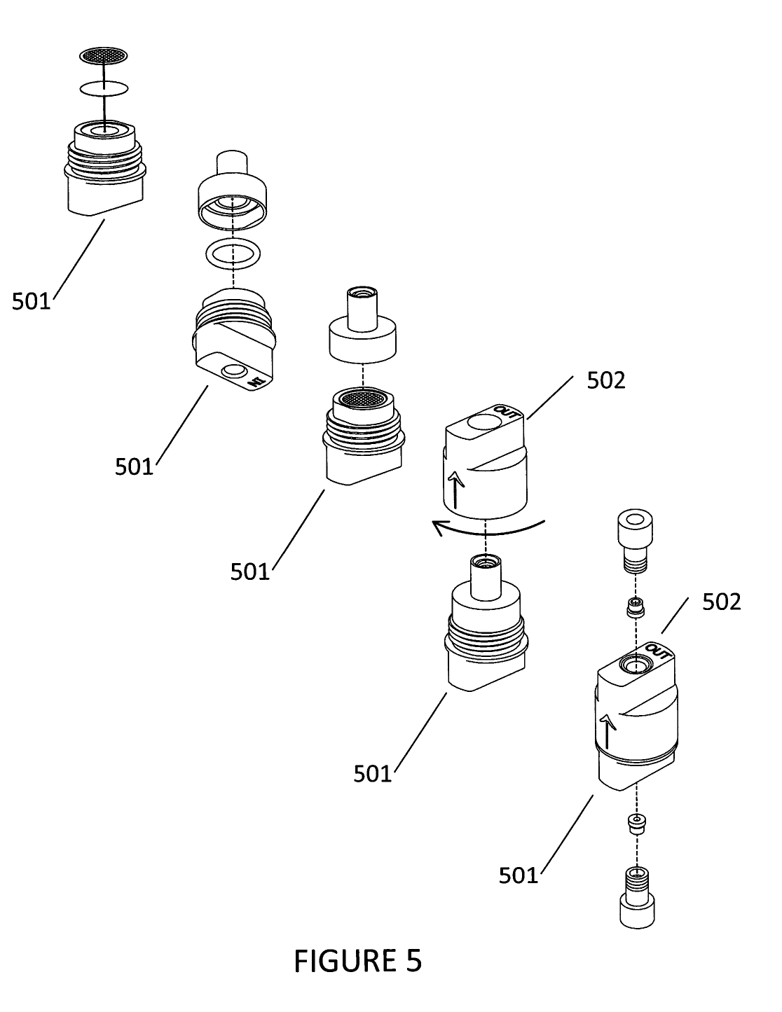

FIGS. 5 exhibits means by which the novel filter housing assembly is put together and the ease with which the elements are combined. The filter housing elements 501 and 502 may be screwed together by hand without the need for tools, and the finger tight seal is adequate for even high pressure systems. The same is true when connecting the filter housing assembly to the flowing system by means of finger tight fittings, either cone or flangeless, thus obviating the need for any tools.

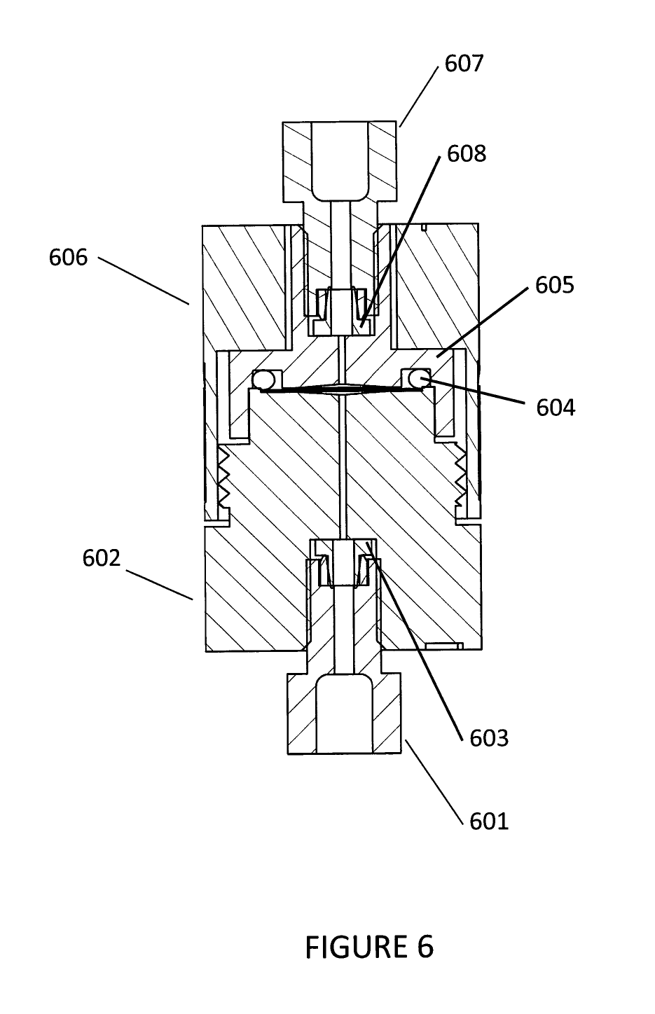

A cross section of the assembled filter housing assembly is illustrated in FIG. 6. In the fully assembled filter housing, the inlet fitting 601 is screwed into the inlet filter housing 602. Ferrule element 603 holds the inlet tubing (not shown) in place. The filter element and retaining screen element are sealed by the compressed O-ring 604 which is placed between the filter and retaining screen elements and the O-ring retainer 605. The O-ring retainer 605 compresses the O-ring 604 by means of downward pressure applied on the O-ring retainer by the outlet filter housing 606 which is screwed onto the inlet filter housing 602. The outlet fitting 607 is threaded into the O-ring retainer 605 and presses upon the outlet ferrule element 608.

Each element of the novel filter housing assembly may be made of a material suitable for the desired application. For example, if aqueous buffers are to be filtered, it may be important that all wetted elements be non-reactive therewith, and thus wetted elements may be made of polyether ether keytone (PEEK), which is an organic polymer thermoplastic commonly used in HPLC systems. Alternatively, some organic solvents are incompatible with PEEK, and therefore wetted elements may be made of stainless steel. In other embodiments of the invention, some elements may be made of one material, and other elements may be made of another material. Also non-wetted elements may be chosen for attributes other than reactivity with solvents and samples, such as ease of manufacture, expense or mechanical durability. For example, the outlet filter housing is generally non-wetted, and therefore it could be made of a very durable material such as stainless steel while the remainder of the elements might be made of PEEK.

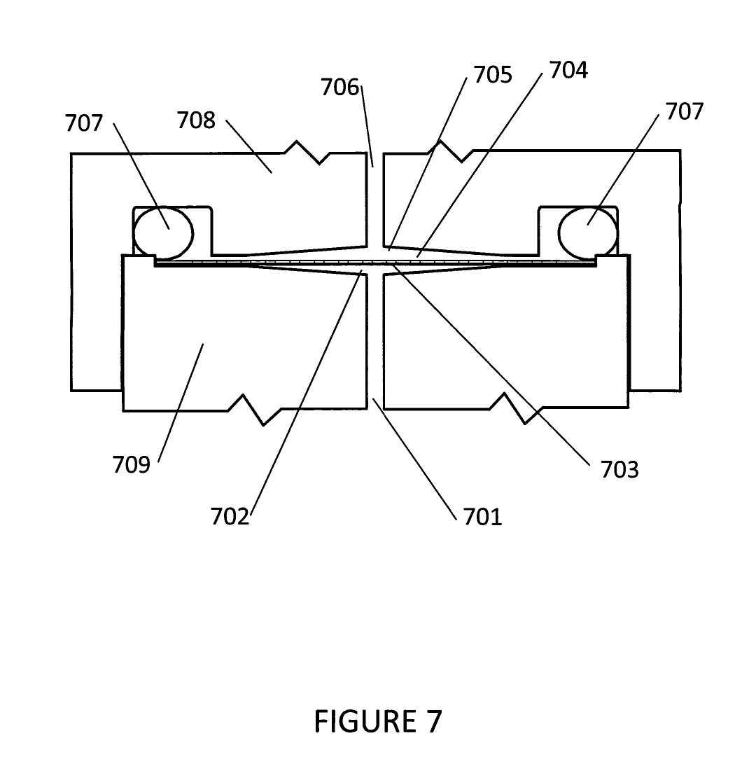

One important element of the invention is the retaining screen element 403 as shown in FIG. 4. In a preferred embodiment, this element is made of stainless steel and is porous in the central regions of its generally circular shape, but is non-porous at the perimeter, as discussed above. This embodiment enables a particularly good seal and minimizes potential leakage. However, other incarnations of this retaining element are possible. For example, the filter retaining element might be manufactured in the same was as described above, but be fabricated of PEEK rather than stainless steel. Alternatively, it could be made of another material altogether, such as titanium, or a combination of materials, such as a stainless steel screen bound to a PEEK perimeter. Other possible embodiments of the invention do not require that the filter retaining element be non-porous along its perimeter, as the O-ring 604 is capable of sealing the system, as shown in FIG. 6, between the O-ring retainer 605 and the inlet filter housing 602. A close-up cross section of the region surrounding the filter element is shown in FIG. 7. Fluid flows through the inlet channel 701 into the inlet dead volume 702 until it is of adequate pressure to pass through the filter element 703 which is supported by the filter support screen 704 before filling the outlet dead volume 705 and passing into the outlet channel 706. O-ring 707 is compressed such that a seal is maintained between the O-ring retainer 708 and the filter support screen 704 and the inlet housing 709. The inventive design enables maximal use of the surface area of the filter element due to the positioning and shape of the inlet and outlet dead volumes 702 and 705. It is important to note that the absence of a frit as a support structure greatly decreases the dead volume of the assembly. If a frit were required to support the filter element, as is the case in most inline filter housings, a dead volume of at least 204 would likely be added to the system. In one preferred embodiment of the invention, the dead volume of the entire housing assembly is only 114, as opposed to other commercially available filters which, generally, have dead volumes of greater than 50, 60 or 80 μL.

There are many embodiments of the invention that will be obvious to those skilled in the arts of fluid flow and high pressure analytical systems that are but simple variations of the basic invention herein disclosed that do not depart from the fundamental elements that I have listed for their practice; all such variations are but obvious implementations of the invention described hereinbefore and are included by reference to our claims, which follow.

1. An inline filter housing capable of operating at pressures above 100 psi comprising
A) a first filter housing element comprising a radially engaging surface, and defining a path through which a fluid may flow from an inlet port capable of receiving a threaded inlet fitting;
B) a filter retaining screen element comprising an area through which a fluid may flow;
C) a sealing element which provides a fluid seal between said filter retaining screen or said first filter housing and
D) a sealing element retainer capable of applying sealing pressure to said sealing element means comprising
a. a physically keyed surface that prevents it from rotating relative to said first filter housing element, and
b. a port capable of receiving a threaded outlet fitting; and
E) a second filter housing element comprising a radially engaging surface which may be mated with said radially engaging surface of said first filter housing element, and thereby providing, when said filter housing elements are engaged, adequate sealing pressure.

2. The apparatus of claim 1 wherein retaining screen element is porous near its center and non-porous at and near its perimeter.

3. The apparatus of claim 2 wherein said filter retaining screen element is comprised of stainless steel.

4. The apparatus of claim 2 wherein said filter retaining screen element is comprised of PEEK.

5. The apparatus of claim 1 wherein said sealing element is an O-ring.

6. The apparatus of claim 1 wherein said second filter housing element is comprised of stainless steel.

7. The apparatus of claim 1 wherein said inlet and outlet ports are threaded so as to receive coned fittings.

8. The apparatus of claim 1 wherein said inlet and outlet ports are threaded so as to receive flangeless fittings and associated ferrules.

9. The apparatus of claim 1 wherein said filter housing assembly is capable of operating at pressures above 1000 psi.

10. The apparatus of claim 1 further comprising a ceramic filter membrane located between said filter retaining screen and said sealing element.

11. The apparatus of claim 1 further comprising a flexible membrane filter located between said filter retaining screen and said sealing element.

12. The apparatus of claim 10 wherein said ceramic filter membrane is circular in shape.

13. The apparatus of claim 11 wherein said flexible membrane filter is circular in shape.

14. The apparatus of claim 1 wherein all wetted surfaces are made of PEEK.

15. The apparatus of claim 1 wherein all wetted surfaces are made of stainless steel.

16. The apparatus of claim 1 wherein the total dead volume of the filter housing assembly is less than 124.

17. The apparatus of claim 1 wherein said second filter housing element is fabricated of stainless steel.

18. The apparatus of claim 1 wherein said inline filter housing may be assembled by hand without the use of any tools.

19. The apparatus of claim 1 wherein said inline filter housing assembly is fritless.

20. The apparatus of claim 1 wherein said sealing element is a gasket.
